(19) United States
(12) Patent Application Publication
(10) Pub. No.: US 2011/0302933 A1
(43) Pub. Date: Dec. 15, 2011

(54) STORAGE AND SUPPLY SYSTEM OF LIQUEFIED AND CONDENSED HYDROGEN

(75) Inventor: Rainer Immel, Dexheim (DE)

(73) Assignee: GM GLOBAL TECHNOLOGY OPERATIONS, INC., Detroit, MI (US)

(21) Appl. No.: 12/815,650

(22) Filed: Jun. 15, 2010

(51) Int. Cl. F25B 19/00; F17C 13/00; F17C 1/12

(52) U.S. Cl. 62/51.1; 220/560.1; 220/560.12

(57) ABSTRACT

A hydrogen storage and supply system comprises a storage vessel containing a liquefied or condensed hydrogen in sufficient contact with a catalyst inside the vessel. The storage vessel comprises an inner tank, an outer jacket, a vacuum insulation between said inner tank and outer jacket, and a catalyst disposed inside the inner tank, wherein the catalyst is capable of converting para-hydrogen to ortho-hydrogen at temperatures between about 20° K to about 80° K. A process of storing and supplying hydrogen using the system is also disclosed.

### TECHNICAL FIELD

The field to which the disclosure generally relates includes hydrogen storage and supply systems.

### BACKGROUND

Hydrogen is a clean and efficient energy source for fuel cells and internal combustion engines. One of the hurdles for adopting hydrogen as a commercially viable fuel is the technical difficulty of building an economical and reliable hydrogen storage and distribution system. Particularly, reliable and economical storage of hydrogen for extended periods of time is technically challenging. Hydrogen storage in compressed gas requires high pressure. At such high pressure, hydrogen gas can diffuse through the container over time. Tank failure and damage can also be a problem in high pressure storage. High pressure containers also add significant mass to a mobile storage unit. Hydrogen can also be stored in the form of metal hydrides. But metal hydrides can contribute to contaminants. Additionally, metal hydrides can add 50 times more weight than that of the stored hydrogen. Liquid hydrogen can be stored at low temperature (<100° K) and relatively low pressure. Due to large temperature differences between the liquid hydrogen and the surrounding environment, natural parasitic heat can leak into a hydrogen storage tank over an extended period of time. Such parasitic heat can cause conversion of some of the liquid hydrogen into hydrogen gas, resulting in a pressure rise inside the tank. Eventually, a certain amount of hydrogen gas may need to be vented in order to avoid overpressure in the tank. As a result, liquid hydrogen storage can experience high boil off rates and short times before a given temperature increase will cause a boil off valve to reach its pressure set-point and open to relieve pressure in the tank.

### SUMMARY OF EXEMPLARY EMBODIMENTS OF THE INVENTION

In one embodiment, a storage device for liquefied or condensed hydrogen is provided. The device comprises an inner tank, an outer jacket, a vacuum insulation between the inner tank and the outer jacket, and a catalyst disposed inside the inner tank. The catalyst is capable of converting para-hydrogen to ortho-hydrogen at temperatures between about 20° K to about 80° K.

In another embodiment, a hydrogen supply system is provided. The hydrogen supply system comprises a storage vessel having a para-hydrogen to ortho-hydrogen conversion catalyst disposed in the inner tank, a liquefied or condensed hydrogen having sufficient contact with the catalyst at a temperature between about 20° K to about 80° K, and a boil off valve that limits the pressure inside the inner tank to the range of about 4 to 30 bar.

Another embodiment includes a process of storing and supplying hydrogen fuel.

Other exemplary embodiments will become apparent from the detailed description provided herein. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 is a schematic drawing of a cylindrical vacuum insulated liquefied or condensed hydrogen storage vessel with a catalyst coating on the interior surface of the inner tank.

FIG. 2 is a schematic drawing of a cylindrical vacuum insulated liquefied or condensed hydrogen storage vessel with a microporous catalyst solid disposed inside the inner tank.

FIG. 3 is a graph showing the plot of equilibrium fractions of para-hydrogen and ortho-hydrogen versus temperature.

FIG. 4 is a graph showing the plot of specific heat versus temperature for different hydrogen modifications at constant volume.

FIG. 5 is a graph showing the plot of internal energy versus temperature for different hydrogen modifications.

FIG. 6 is a graph showing the plot of dormancy gains of a liquefied hydrogen storage and supply system that includes a catalyst over a similar system without a catalyst at several filling levels and boil off pressures.

### DETAILED DESCRIPTION OF EXEMPLARY EMBODIMENTS

The following description of the embodiments is merely exemplary in nature and is in no way intended to limit the invention, its application, or uses.

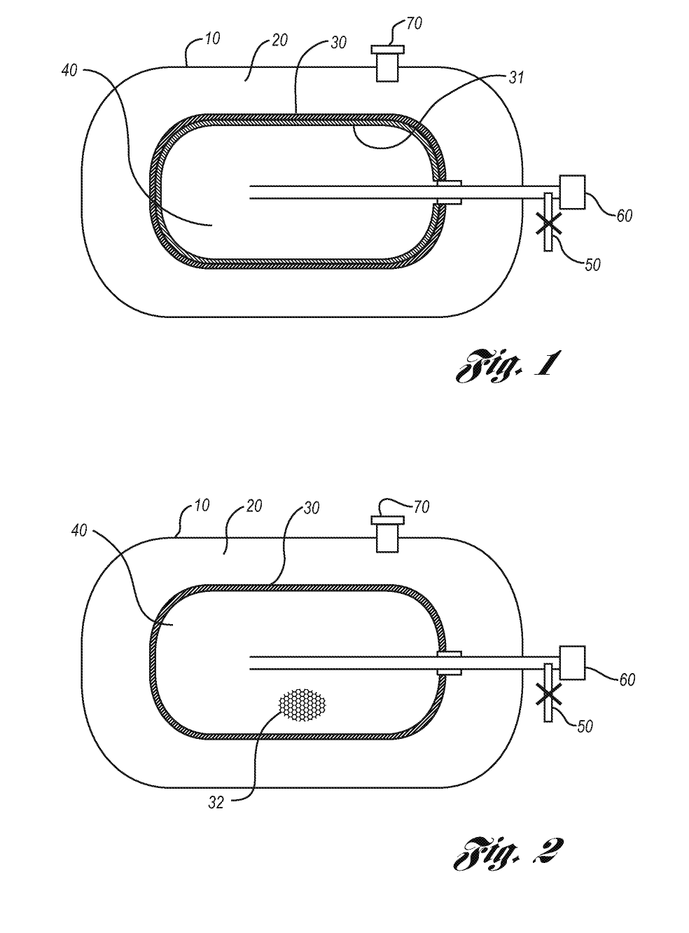

One embodiment of a hydrogen storage vessel and supply system is shown schematically in the drawing of FIG. 1. The system can include an outer jacket 10, an inner tank 30, a vacuum insulation 20 between the outer jacket 10 and inner tank 30, a catalyst coating 31 on the interior surface of the inner tank 30, and a boil off valve 50 connected to the inner tank. Liquefied or condensed hydrogen 40 at a temperature between about 20°-80° Kelvin (hereafter abbreviated as “K”) can be stored inside the inner tank. The storage vessel and supply system may further include a filling and discharging port 60 and a vacuum/access port 70.

Another embodiment of a hydrogen storage vessel and supply system is shown schematically FIG. 2. In this embodiment a solid porous catalyst 32 may disposed inside the inner tank. The stored hydrogen in the inner tank is in sufficient contact with the catalyst. Other embodiments may include both a catalyst coating and a solid porous catalyst or a catalyst in another form.

As shown in the above two embodiments in FIG. 1 and FIG. 2, a cylindrical vessel design provides good space utilization, especially in mobile storage applications. Cylindrical vessel design also avoids stress concentration points and is easy to manufacture. Other shapes and configurations, such as spherical, elliptical or other configurations, can also be used in this invention.

The outer jacket 10 can be made of any material or combination of materials having suitable strength and permeability characteristics. The outer jacket 10 may be impermeable to air and can be chosen such that its strength is sufficient to withstand the stresses created by a vacuum that may exist in the insulation layer 20. Suitable outer jacket materials may include, but are not limited to, plastics, metals, fiber composites, ceramics, other materials, any combination thereof, and in some exemplary embodiments may include multiple layers of the same or different materials.

The inner tank 30 may be made of any material or combination of materials having suitable strength and permeability characteristics. It is preferably at least partially, or substantially completely, impermeable to hydrogen liquid and gas at relatively low pressures (4-60 bars). The material or materials may be selected to have high strength at low temperatures to withstand stresses generated by a potentially large pressure differential between the low pressure vacuum insulation outside the inner tank and high pressure hydrogen inside the inner tank, particularly in embodiments where such a differential exists. Various metals, ceramics, fiber composites and other materials alone or in combination can be used to construct the inner tank. A fiber composite lined with aluminum or an aluminum alloy may be preferred due to the hydrogen barrier properties of aluminum and its alloys and additionally due to its relatively lightweight as a metal. One example of a fiber composite suitable for use in construction of the inner tank includes fibers having high mechanical strength at low temperature, high modulus, and low elongation. Aramide fibers, such as KEVLAR™ marketed by DuPont, fiber glass, and carbon fibers are some non-limiting examples of suitable fibers. Additional details of constructing an exemplary composite vessel material is described in Baur L., 1995, “Composite Pressure Vessel with Metal Liner for Compressed Hydrogen Storage,” Proceedings of the 1^{st} IEA Workshop on Fuel Processing for Polymer Electrolyte Fuel Cells, Paul Scherrer Institut, Villigen, Switzerland, International Energy Agency, Swiss Federal Office of Energy, Sep. 25-27, 1995, p. 45-69. But of course this is only one of several examples of suitable composite material usage in for the inner tank 30.

The vacuum insulation 20 is preferably a multilayer vacuum super insulation (MLVSI), as described in Aceves, S. M., Berry, G. D., 1998, “Thermodynamics of Insulated Pressure Vessels for Vehicular Hydrogen Storage,” ASME Journal of Energy Resources Technology, June, Vol. 120, pp. 137-142. The vacuum inside the insulation is preferably less than about 0.01 Pascal. Microsphere, foamed materials, and/or certain insulating fibers can be used to form such multilayer vacuum insulation.

Liquid hydrogen has a boiling point of 20.28° K. It can be stored at about 20°-50° Kelvin. The temperature requirements for liquid hydrogen storage necessitate expending a great deal of energy to compress and chill the hydrogen into its liquid state.

Hydrogen may also be adsorbed onto solid adsorbents such as activated carbon, carbon nanotubes, metal organic frameworks and graphite fibers at cryogenic temperatures. Hydrogen adsorbed on solid adsorbent at cryogenic temperatures is referred to herein as condensed hydrogen. Condensed hydrogen can be stored at relative higher temperatures than liquid hydrogen.

A boil off safety valve 50 may be connected to the inner tank to limit the hydrogen storage pressure between about 2 bar and about 60 bars, and preferably, between about 4 and about 30 bars. When the pressure inside the inner tank rises to the upper limit set for the boil off valve, the valve can automatically open to vent hydrogen gas away from the inner tank. Such venting process not only reduces the pressure in the inner tank for safety reasons, but also cools the inner tank. The resultant cooling due to gas expansion and evaporation of liquid hydrogen can slow any pressure rise in the tank. The margin of safety concerning liquid or condensed hydrogen storage is a function of maintaining tank integrity and preserving the temperatures that liquid or condensed hydrogen requires. The venting mechanism of the boil off valve can be controlled mechanically or electronically. Any pressure regulating vent valves known in the art can be used as the boil off valve.

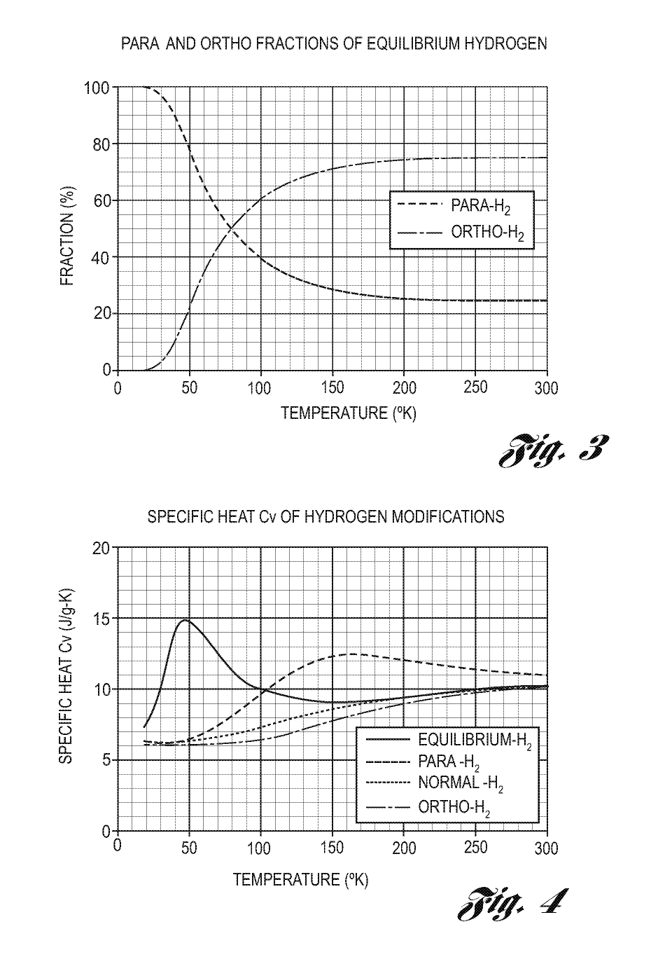

The spins of the atomic nuclei in a hydrogen molecule can be coupled in two distinct ways: with nuclear spins parallel (ortho-hydrogen) or nuclear spins anti-parallel (para-hydrogen). Because molecular spins are quantized, ortho- and para-hydrogen exist in different quantum states. As a result, there are differences in many properties of the two forms of hydrogen. In particular, those properties that involve heat, such as enthalpy, entropy, and thermal conductivity, can show definite differences for ortho- versus para-hydrogen. Para-hydrogen is the lower energy form of hydrogen at liquid state. FIG. 3 shows the thermodynamic equilibrium fractions of ortho- and para-hydrogen at different temperatures. The hydrogen having equilibrium makeup of ortho- and para-hydrogen at a given temperature is called equilibrium hydrogen. At temperatures of 300 K and higher, the hydrogen composition asymptotically approaches a distribution of 25% para- and 75% ortho-hydrogen. This fixed 1:3 ratio of para- and ortho-hydrogen composition is referred to as “normal hydrogen”. Different forms and compositions of hydrogen are referred to here as different hydrogen modifications. As shown in FIG. 3, at equilibrium at 20° K hydrogen exists almost exclusively as para-hydrogen. In other words, equilibrium hydrogen at 20° K is essentially para-hydrogen.

As can be seen in FIG. 3, when the temperature increases from 20° to 80° K, the equilibrium composition of hydrogen shifts sharply from virtually all para-hydrogen to about 50% para-hydrogen. However, equilibrium conditions of ortho- and para-hydrogen are often not realized because the uncatalyzed interconversion of the two forms is very slow at low temperatures. Since para-hydrogen has lower internal energy than ortho-hydrogen at 20° K, hydrogen is converted catalytically into para-hydrogen before being stored in liquid form. The storage and supply system according to the invention is therefore preferably filled and/or refilled with liquid para-hydrogen.

When temperature rises during extended period of storage, para-hydrogen in a storage tank does not get converted into the equilibrium composition of ortho- and para-hydrogen in the absence of a catalyst. In some known storage systems where evaporated hydrogen is cooled and recycled into liquid hydrogen, it may be desirable to maintain para-hydrogen composition in storage even when the temperature fluctuates over 20° to 80° K range. In those types of systems, contact of stored hydrogen with a catalyst is necessarily avoided.

In storage and supply systems such as those shown in FIGS. 1 and 2 and described herein, where vented hydrogen is not recycled back into the stored liquid hydrogen, the applicant has found that having the stored hydrogen in sufficient contact with a catalyst during storage is preferred. Including a catalyst in sufficient contact with stored hydrogen is found herein to extend storage time with less evaporative loss.

The catalyst may include any materials that are capable of catalyzing the conversion of para-hydrogen to ortho-hydrogen in the temperatures between about 20° K and about 80° K. Suitable catalysts include, but are not limited to, iron oxide (especially iron(III) oxide), platinum, rhenium, ruthenium, rhodium phosphine complexes, Group IV-VI transition metal nitrides, samarium copper, potassium-triphenylene complex, titanium carbide, manganese carbides, chromia-alumina, molybdenum-alumina, sodium hydride, chromium potassium sulfate, copper-nickel zeolite, cobalt zeolite, manganese oxide, carbonaceous substances such as graphite, and any combination/mixtures thereof. The catalyst should be relatively pure, and should not contribute to any gaseous contaminants such as carbon monoxide, ammonia, sulfur compounds or other contaminants. In one embodiment as shown in FIG. 1, the catalyst 31 is coated on the interior surface of the inner tank. In another embodiment as shown in FIG. 2, the catalyst 32 is disposed in the inner tank as a microporous solid. The microporous solid can provide an overall surface area much larger than the geometric surface area of the solid. Such large surface area can allow sufficient contact with the hydrogen inside the inner tank for effective catalytic conversion of para- to ortho-hydrogen as temperature rises during storage. It is also possible to include both the catalyst coating 31 and the microporous catalyst 32 within the same tank.

One effect of the catalyst on hydrogen storage according to the invention can be described with reference to FIG. 4. FIG. 4 is a graph showing the specific heat of gaseous hydrogen at constant volume, Cv, and at temperatures ranging from 20° K to 300° K for different hydrogen modifications including para-, ortho-, normal and equilibrium hydrogen. Specific heat data for these different hydrogen modifications is readily available from public or commercially available databases such as NIST (www.nist.gov/srd/nist12.htm) or Gaspak (www.htess.com/gaspak.htm).

The curve for para-hydrogen represents the condition where liquefied para-hydrogen is filled in a tank without any catalyst. Because, as explained above, the conversion process from para- to ortho-hydrogen is very slow, the hydrogen remains in its pure para-hydrogen state without any significant conversion to ortho-hydrogen in the temperature range of 20° K-60° K. As indicated in FIG. 4, the specific heat of gaseous para-hydrogen is almost constant at about 6.5 J/g K over the temperature range of 20°-60° K.

Where a catalyst is included in the inner tank as in the embodiments shown and described in FIGS. 1 and 2, para-hydrogen may be sufficiently converted to ortho-hydrogen to reach an overall equilibrium hydrogen state. The curve of equilibrium hydrogen in FIG. 4 represents the resulting specific heat of the mixture. In comparison to the relatively flat para-hydrogen curve, the equilibrium hydrogen curve shows a dramatic increase in heat capacity (from 7 to 15 J/g-K) when the temperature rises from 20° K to about 50° K.

When the exemplary storage vessels described herein are initially filled with liquefied para-hydrogen at about 20.2° K in the presence of the catalyst, it is converted to equilibrium hydrogen. As a result, it takes much more parasitic heat leak to raise the temperature from 20.2° K to 50° K due to the increase in heat capacity of the stored hydrogen. The increase in heat capacity for equilibrium hydrogen at temperature range of 20°-50° K is due to the additional energy required for the conversion of a portion of para-hydrogen to ortho-hydrogen. Such dramatic increase in heat capacity can significantly slow temperature and pressure rises in the inner tank, thus extending the dormancy time of the stored hydrogen. In one embodiment, the temperature of stored hydrogen is in the range of 20°-80° K, and preferably 20°-60° K. As also shown in FIG. 4, the heat capacity of equilibrium hydrogen decreases as temperatures increase above about 50° K. At about 80°-100° K, the heat capacity of equilibrium hydrogen approaches the value of normal-hydrogen. The benefit of the higher heat capacity provided by the catalyst in the storage and supply system starts to decrease when temperatures rise past about 80° K or greater.

The beneficial effect of the hydrogen storage and supply system described herein can also be demonstrated with reference to FIG. 5 where the internal energy of different gaseous hydrogen modifications is plotted versus temperature. The internal energy is calculated by taking the integral of specific heat (at constant volume, Cv) over temperature. As shown in FIG. 5, the internal energy of equilibrium hydrogen, which results in a storage system including the catalyst described herein, in the temperature range of 20°-80° K shows a much larger increase than that of the corresponding para-hydrogen, which exists in storage tanks where no catalyst is present. Accordingly, for the same amount of parasitic heat leak at storage temperature in 20°-80° K range, hydrogen stored in tanks including catalyst as described can experience much lower rises in temperature and pressure than para-hydrogen in a similar storage system without the catalyst.

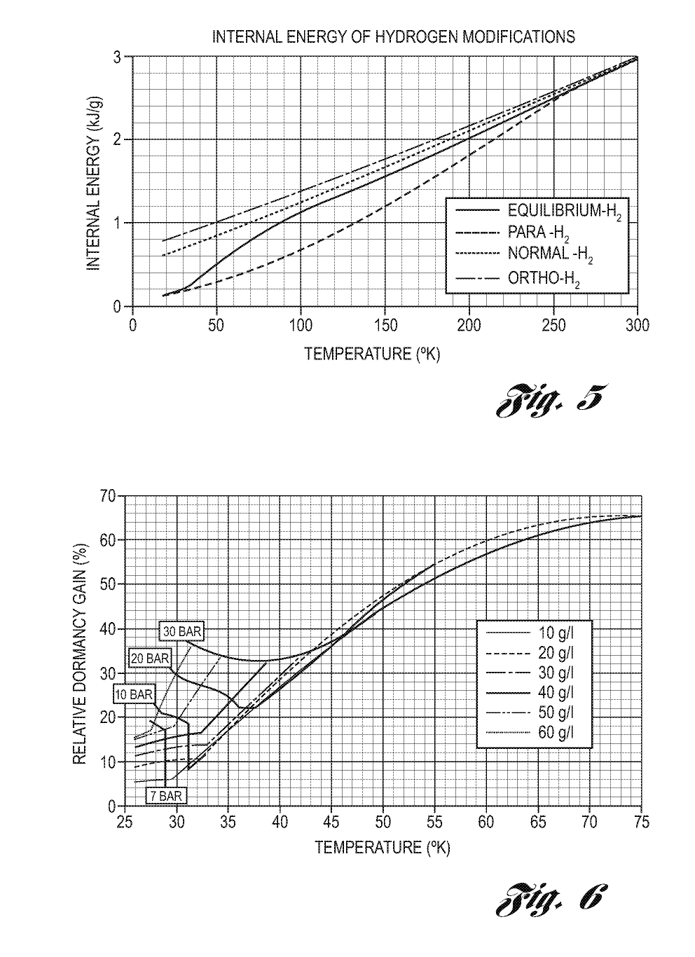

Loss free dormancy time of the hydrogen storage and supply system can calculated at different boil off pressures and compared to a similar system without the use of a catalyst. Loss free dormancy time as used herein is defined as the time for a storage system starting at 26° K at 4 bar to reach a pre-set boil off pressure. Relative dormancy gain is the calculated percentage increase in loss free dormancy time of the storage and supply system that includes a catalyst, and is thus storing hydrogen in its equilibrium state, compared to that of a similar system without a catalyst, which would be storing hydrogen in its para-state. Relative dormancy gain curves of different filling levels (indicated in g/l) and boil off pressures (indicated in MPa) are shown in FIG. 6. To create the curves in FIG. 6, a baseline dormancy time is calculated for para-hydrogen, and a second dormancy time is calculated for equilibrium hydrogen. The dormancy times are calculated by calculating the time required at each temperature at a constant volume for the pressure in the tank to reach the boil off pressure set-point of the valve based on the specific heat capacity. The relative dormancy gain is then calculated by taking the difference between the second dormancy time (representing the equilibrium hydrogen) and the baseline dormancy time (representing the para-hydrogen) and dividing the difference by the baseline dormancy time of the para-hydrogen. Thus, a relative dormancy gain is calculated for a hydrogen storage system that includes a catalyst as described herein.

By way of example and explanation of the chart in FIG. 6, all lines in the chart refer to a starting condition at 4 bar pressure and 26° K temperature. The six curves that start at 26° K represent six different tank filling levels, and the four curves that cross the different tank filling level curves represent four different boil off pressures for the tank, the boil off pressure usually being a constant design parameter for a given tank/valve construction. Following the g/l curve, for example, shows that the relative dormancy gain for a tank that includes a valve with a boil-off pressure set-point of 20 bar (or 2 MPa) is 22%, indicating that a tank filled with equilibrium hydrogen, such as a tank that includes the catalyst described herein, has a 22% longer dormancy time before the pressure set-point is reached than does a tank that does not include the catalyst and therefore contains only para-hydrogen.

Filling level is the weight of filled hydrogen per unit volume of the storage space in the inner tank. A filling level of 5 to about 60 gram/liter is suitable. As shown in FIG. 6, sharper increase in dormancy gains is indicated for higher filling levels due to the additional mass of hydrogen available to absorb parasitic heat and the associated gain of having that hydrogen in its equilibrium state. Additionally, higher boil off pressure results in not only longer loss free dormancy time, but also higher dormancy gain. Boil off pressure of the hydrogen storage and supply system is preferably 15 to about 60 bar. Dormancy gain between 10% to up to 65% can be achieved depending on the filling level and boil off pressure.

Since most of the heat leaks occur through the wall of the inner tank, the catalyst coating on the interior surface of the inner tank is most efficient in converting the heat leak into energy for para- to ortho-hydrogen transformation. The catalyst coating can be easy produced by spray coating, dip coating, vapor deposition, sputtering, and other methods known in the art.

The storage vessel and system may also include other features and components. The access and vacuum port 70, for example, can be used to provide and maintain high vacuum for the insulation. It can also serve as the port for repairs and for placing temperature and pressure monitoring probes. To further extend the loss free dormancy time, an evaporative vapor shield can also be provided. The storage and supply system may have a separate discharging line and filling line. The discharging line can provide hydrogen gas output and the filling line can allow the inflow of liquefied hydrogen to fill the inner tank.

The hydrogen storage and supply system is especially suitable as a mobile unit to supply hydrogen fuel to an internal combustion engine or a fuel cell. In one embodiment, the storage and supply system can be filled initially with liquefied hydrogen that was previously catalytically converted into greater than 90% para-hydrogen at about 20°-30° K. The storage and supply system is then connected to the fuel line of a fuel cell or an internal combustion engine. For example, the embodiments as shown in FIG. 1 and FIG. 2 can be connected to the fuel line of a fuel cell or an internal combustion engine through a coupling joint. As temperature and pressure inside the inner tank rise to a preset value in the inner tank due to extended period of idle or storage time, the boil off valve opens to vent small amount of hydrogen gas to lower the tank pressure to a value slightly less than the boil off pressure. As fuel supply for fuel cells, the hydrogen is preferably at least 99.9% pure. Particularly, impurities such as ammonia, carbon monoxide, and sulfur compounds should be substantially removed to avoid poisoning or contaminating the catalysts or the membranes in a fuel cell. Due to its high hydrogen storage density, low pressure, long loss free dormancy time and light weight, the liquid hydrogen storage and supply system described herein may be especially suitable as a fuel storage and supply unit in a vehicle powered by a fuel cell, an internal combustion engine or a hybrid energy device. Other electrical or electronics devices powered by hydrogen fuel can also use such a hydrogen storage and supply system.

The above description of embodiments of the invention is merely exemplary in nature and, thus, variations thereof are not to be regarded as a departure from the spirit and scope of the invention.

What is claimed is:

1. A liquefied or condensed hydrogen storage device comprising an inner tank, an outer jacket, a vacuum insulation between said inner tank and outer jacket, and a catalyst disposed inside said inner tank; wherein said catalyst is capable of converting para-hydrogen to ortho-hydrogen at temperatures between about 20° K and about 80° K.

2. A liquefied or condensed hydrogen storage device as set forth in claim 1, wherein said inner tank and outer jacket are substantially cylindrical in shape.

3. A liquefied or condensed hydrogen storage device as set forth in claim 1, further comprising a boil off valve connected to the inner tank that limits the pressure inside said inner tank to under about 60 bar.

4. A liquefied or condensed hydrogen storage device as set forth in claim 1, wherein said catalyst is disposed as either a coating on at least part of the interior surface of said inner tank or a microporous solid inside said inner tank.

5. A liquefied or condensed hydrogen storage device as set forth in claim 1, wherein said catalyst comprises at least one of iron oxide, platinum, rhenium, ruthenium, rhodium phosphine complexes, Group IV-VI transition metal nitrides, samarium copper, potassium-triphenylene complex, titanium carbide, manganese carbides, chromia-alumina, molybdenum-alumina, sodium hydride, chromium potassium sulfate, copper-nickel zeolite, cobalt zeolite, manganese oxide, and carbonaceous substances.

6. A liquefied or condensed hydrogen storage device as set forth in claim 1, wherein said catalyst comprises iron oxide.

7. A liquefied or condensed hydrogen storage device as set forth in claim 1, wherein said vacuum insulation comprises multilayer vacuum super insulation.

8. A liquefied or condensed hydrogen storage device as set forth in claim 1, wherein said inner tank comprises metal lined composite wrap material.

9. A liquefied or condensed hydrogen storage device as set forth in claim 8, wherein said metal comprises aluminum or aluminum alloy and said composite wrap comprises carbon fiber, glass fiber or aramide fiber based composite.

10. A hydrogen supply system comprising:
a storage vessel comprising an inner tank, an outer jacket, a vacuum insulation between said inner tank and outer jacket, and a catalyst disposed inside said inner tank, wherein said catalyst is capable of converting para-hydrogen to ortho-hydrogen at temperatures between about 20° K and about 80° K;
a liquefied or condensed hydrogen having sufficient contact with said catalyst inside said inner tank; and
a boil off valve connected to said inner tank to limit the pressure inside said inner tank to less than about 60 bar.

11. A hydrogen supply system as set forth in claim 10, wherein said inner tank and outer jacket are substantially cylindrical in shape.

12. A hydrogen supply system as set forth in claim 10, wherein said inner tank comprises metal lined fiber composite wrap.

13. A hydrogen supply system as set forth in claim 12, wherein said metal comprises aluminum or aluminum alloy and said fiber comprises carbon fiber, glass fiber or aramide fiber.

14. A hydrogen supply system as set forth in claim 10, wherein said liquefied or condensed hydrogen is at least 99.9% pure, and stored at a temperature between about 20° K and about 80° K.

15. A hydrogen supply system as set forth in claim 10, wherein said pressure inside said inner tank is between 4 bar and 30 bar.

16. A hydrogen supply system as set forth in claim 10, wherein said catalyst is either a coating on at least part of the interior surface of said inner tank or a microporous solid disposed inside said inner tank.

17. A hydrogen supply system as set forth in claim 10, wherein said catalyst comprises at least one of iron oxide, platinum, rhenium, ruthenium, rhodium phosphine complexes, Group IV-VI transition metal nitrides, samarium copper, potassium-triphenylene complex, titanium carbide, manganese carbides, chromia-alumina, molybdenum-alumina, sodium hydride, chromium potassium sulfate, copper-nickel zeolite, cobalt zeolite, manganese oxide, and carbonaceous substances.

18. A hydrogen supply system as set forth in claim 10, wherein said catalyst comprises iron oxide.

19. A hydrogen supply system as set forth in claim 10, wherein the hydrogen filling level inside said inner tank is between about 5 and about 60 grams per liter.

20. A hydrogen supply system as set forth in claim 19, wherein said filling level is between about 30 and 60 gram per liter.

21. A process of storing liquefied or condensed hydrogen comprising:
providing a storage vessel comprising an inner tank, an outer jacket, plurality of layered vacuum insulation between said inner tank and outer jacket, a boil off valve connected to said inner tank, and a para-hydrogen to ortho-hydrogen conversion catalyst disposed inside said inner tank;
filling said inner tank with a liquefied hydrogen to about 5-60 grams per liter at temperature between about 20° K and about 60° K; and
venting hydrogen through said boil off valve when the pressure inside the inner tank reaches a pre-set value; wherein the vented hydrogen is not recycled back into liquid hydrogen.

22. A process of storing liquefied or condensed hydrogen as set forth in claim 21, wherein said inner tank and outer jacket are substantially cylindrical in shape.

23. A process of storing liquefied or condensed hydrogen as set forth in claim 21, wherein said catalyst is either a coating on at least part of the interior surface of said inner tank or a microporous solid disposed inside said inner tank.

24. A process of storing liquefied or condensed hydrogen as set forth in claim 21, wherein said catalyst comprises at least one of iron oxide, platinum, rhenium, ruthenium, rhodium phosphine complexes, Group IV-VI transition metal nitrides, samarium copper, potassium-triphenylene complex, titanium carbide, manganese carbides, chromia-alumina, molybdenum-alumina, sodium hydride, chromium potassium sulfate, copper-nickel zeolite, cobalt zeolite, manganese oxide, and carbonaceous substances.

25. A process of storing liquefied or condensed hydrogen as set forth in claim 21, wherein the pressure inside said inner tank is controlled between about 4 bar to about 30 bar through said boil off valve.

26. A process of storing liquefied or condensed hydrogen as set forth in claim 21, wherein said pre-set value is between about 4 bar and about 30 bar.

27. A process of storing liquefied or condensed hydrogen as set forth in claim 21, wherein said liquefied hydrogen consists essentially of para-hydrogen.
